(19) United States
(12) Patent Application Publication
(10) Pub. No.: US 2005/0009968 A1
(43) Pub. Date: Jan. 13, 2005

(54) Transparent Flame Retardant Polycarbonate Compositions

(75) Inventors: Rajendra Kashinath Singh, Evansville, IN (US); Ye-Gang Lin, Evansville, IN (US)

Correspondence Address: OPPEDAHL & LARSON LLP, PO BOX 5068, DILLON, CO, 80435, US

(73) Assignee: GENERAL ELECTRIC COMPANY, Schenectady, NY (US)

(21) Appl. No.: 10/604,166

(22) Filed: Jun. 28, 2003

(51) Int. Cl. C08K 5/24; C08K 5/41

(52) U.S. Cl. 524/155; 524/261

(57) ABSTRACT

Transparent polycarbonate compositions are made from polycarbonate produced in a base-catalyzed melt polymerization reaction to which an acidic quencher has been added in a 1 to 30-fold molar ratio with respect to the amount of initial basic catalyst; and a potassium perfluoralkane sulfonate and cyclic siloxane containing flame-retardant component. In the composition these components work in combination such that the composition achieves a V0 UL flammability rating at a thickness of 2.0 mm, preferably 1.6 mm, and has a haze of no more than 1%.

### BACKGROUND OF INVENTION

The present application relates to fire-retarded transparent polycarbonate compositions, and to a method of making such compositions.

Because of their strength and clarity, polycarbonate resins have a great many significant commercial applications. Unfortunately, polycarbonate resins are inherently flammable and can drip hot molten material causing nearby materials to catch fire as well. Thus, in order to safely utilize polycarbonates in many applications it is necessary to include additives which retard the flammability of the material and/or which reduce dripping. The challenge is to identify additives which accomplish this purpose without compromising the desirable properties of strength and clarity, without introducing new problems (such as the potential environmental problems associated with halogenated additives) and without prohibitively increasing the price.

A variety of different materials have been described for use in producing fire-retarded and/or drip-resistant polycarbonates. Exemplary of these are the materials described in U.S. Pat. Nos. 3,971,756, 4,028,297, 4,110,299, 4,130,530, 4,303,575, 4,335,038, 4,552,911, 4,916,194, 5,218,027 and 5,508,323. Notwithstanding these varied disclosures, however, there remains room for improvement in the formulation of fire-retarded polycarbonate resin, and in particular for transparent compositions.

Among the additives which are widely used commercially in fire-retarded polycarbonate resin compositions are organic salts, particularly sulfonic acid salts. Particular examples of these salts are perfluoroalkane sulfonates, such as potassium perfluorobutane sulfonate (“KPFBS”, also known as “Rimar salt”) and potassium diphenylsulfone sulfonate (“KSS”) which yield haze free compositions when blended with polycarbonate resin. The use of perfluoroalkane sulfonates in polycarbonate resins is described in U.S. Pat. No. 3,775,367. However, the benefits which can be obtained using these materials alone are limited and indeed additional additives are generally included. The conventional means for enhancing the fire-retardant properties of these type of compositions while retaining transparency has been the addition of soluble organic halogen additives. For example, commercial grades of LEXAN polycarbonate resin (eg. 940A, 920A) contain a combination of KSS (0.3 phr) and a tetrabromobisphenol A/bisphenol A copolymer (0.5 phr, net 0.13 phr bromine content). Without the bromine, the 920A and 940A grades have inconsistent/unreliable performance in the UL94 VO 125 mil flammability test that these grades are designed to meet. However, the brominated additive is unsuitable for compositions which are required to meet “ECO-friendly”standards, since these standards prohibit the inclusion of bromine or chlorine.

Commonly assigned U.S. Pat. No. 6,353,046 describes fire-retarded polycarbonate resin compositions that contain a combination of a perfluoroalkane sulfonate and a cyclic siloxane as a synergistic fire-retardant additive. The compositions achieve good fire-retardance in compositions having a thickness of 75 mil (1.9 mm) or greater, but reported drips at 60 mil (1.52 mm). Thus, the compositions of this patent are not ideally suited for thin-wall applications.

In view of the foregoing, there remains a need for means for enhancing the fire-resistant properties of polycarbonate without impairing the transparency of the material, and for compositions which meet fire-resistant standards even in very thin samples. It is an object of the present invention to provide such compositions, and a method for making the compositions.

### SUMMARY OF INVENTION

In accordance with the present invention, transparent polycarbonate compositions comprise: (a) polycarbonate produced in a base-catalyzed melt polymerization reaction to which an acidic quencher has been added in a 1 to 30-fold molar ratio with respect to the amount of initial basic catalyst; and (b) a flame-retardant component comprising a potassium perfluoralkane sulfonate and a cyclic siloxane. In the composition of the invention components (a) and (b) work in combination such that the composition achieves a V0 UL flammability rating at a thickness of 2.0 mm, preferably 1.6 mm, and has a haze of no more than 1%.

### DETAILED DESCRIPTION

Prior to the present invention, it has been difficult to obtain transparent polycarbonate compositions with V0 UL flammability rating at a thickness equal to or less than 1.6 mm. The transparency requirement does not allow use of polytetrafluoroethylene as an anti-dripping agent. Further, the transparency requirement limits the loading level of potassium perfluorobutane sulfonate due to its limited solubility in polycarbonate resin.

The present invention is based on several surprising observations. First, it was observed by the inventors that polycarbonate produced via a base-catalyzed, for example sodium hydroxide-catalyzed, melt polymerization has a significantly higher solubility for perfluoroalkane sulfonates without loss of transparency. Secondly, the flame retardancy of the perfluoroalkane sulfonate was significantly improved by the presence of the residual base catalyst. Furthermore, it appears that there is an optimum range of residual base catalyst that allows enhancement of flame performance. Excessive base catalyst can result in the decay of flame performance. In this invention, the optimum level of residual base catalyst is achieved by controlling the acid quencher loading to a level which is in the range of 1-30 fold molar ratio with respect to the initial base catalyst. Using such loadings, the effectiveness of fire-retardant compositions such as those described in U.S. Pat. No. 6,353,046 comprising a perfluoroalkane sulfonate and a cyclic siloxane are increased to obtain V0 UL flammability ratings at thicknesses of 1.6 mm, while retaining high levels of transparency. Thus, the present invention provides a polycarbonate composition comprising: (a) polycarbonate produced in a base-catalyzed melt polymerization reaction to which an acidic quencher has been added in a 1 to 30-fold molar ratio with respect to the initial basic catalyst; and (b) a flame-retardant component comprising a potassium perfluoralkane sulfonate and a cyclic siloxane, wherein components (a) and (b) work in combination such that the composition achieves a V0 UL flammability rating at a thickness of 2.0 mm and has a haze of no more than 1%.

Polycarbonate Component

Preparation of polycarbonate compositions by melt polycondensation reaction is known in the art, for example from U.S. Pat. Nos. 5,717,057, 5,606,007 and 5,319,066, which are incorporated herein by reference. In general, the polycarbonate component used in the method of the invention is a polycarbonate resulting from the base-catalyzed reaction of a diaryl carbonate and a dihydric phenol. A variety of diaryl carbonates and dihydric phenols are used to create polycarbonates of varying properties. Non-limiting examples of diaryl carbonates are diphenylcarbonate (DPC), ditolyl carbonate, bis(chlorophenyl)carbonate, m-cresyl carbonate, dinapthyl carbonate, bis(diphenyl)carbonate, diethyl carbonate, dimethyl carbonate, dibutyl carbonate and dicyclohexyl carbonate, bis(metriylsalicyl) carbonate. Non-limiting examples of dihydric phenols are 1,1-bis (4-hydroxyphenyl)methane; 1,1-bis(4-hydroxyphenyl)ethane; 2,2-bis(4-hydroxyphenyl) propane (hereinafter “bisphenol A” or “BPA”); 2,2-bis(4-hydroxyphenyl) butane; 2,2-bis(4-hydroxyphenyl)octane; 1,1-bis(4-hydroxyphenyl) propane; 1,1-bis(4-hydroxyphenyl)n-butane; bis(4-hydroxyphenyl) phenylmethane; 2,2-bis(4-hydroxy-1-methylphenyl)propane; 1,1-bis(4-hydroxy-t-butylphenyl)propane; bis(hydroxyaryl)alkanes such as 2,2-bis(4-hydroxy-3-bromophenyl) propane; 1,1-bis(4-hydroxyphenyl)cyclopentane; 4,4′-biphenol; and bis(hydroxyaryl)cycloalkanes such as 1,1-bis(4-hydroxyphenyl) cyclohexane. A common combination used in indistrial polycarbonate production is DPC and BPA.

Base Catalyst

The polycarbonate component used in the present invention is the product of a base-catalyzed melt polymerization reaction. Bases commonly employed in such reaction include sodium hydroxide, potassium hydroxide, lithium hydroxide, sodium hydrogencarbonate, potassium hydrogencarbonate, lithium hydrogencarbonate, sodium carbonate, potassium carbonate, lithium carbonate, sodium acetate, potassium acetate, lithium acetate, sodium stearate, potassium stearate, lithium stearate, sodium borohydride, lithium borohydride, sodium borophenylate, sodium benzoate, potassium benzoate, lithium benzoate, disodium hydrogenphosphate, dipotassium hydrogenphosphate, dilithium hydrogenphosphate, sodium phenylate, potassium phenylate, lithium phenylate, sodium borohydride, potassium borohydride, lithium borohydride. calcium hydroxide, barium hydroxide, magnesium hydroxide, strontium hydroxide, calcium hydrogencarbonate, barium hydrogencarbonate, magnesium hydrogenstrontium hydrogencarbonate, calcium carbonate, barium carbonate, magnesium carbonate, strontiun carbonate, calcium acetate, barium acetate, magnesium acetate, strontium acetate, calcium stearate, barium stearate, magnesium stearate, and strontium stearate and a quaternary ammonium compound or a quaternary phosphonium compound, such as those described in the previously-mentioned U.S. Pat. No. 5,340,905. Non-limiting examples of these quaternary compounds include tetramethyl ammonium hydroxide, tetramethyl ammonium acetate, tetramethyl ammonium fluoride, tetramethyl ammonium tetraphenyl borate, tetraphenyl phosphonium fluoride, tetraphenyl phosphonium tetraphenyl borate, tetrabutyl phosphonium hydroxide, and dimethyl diphenyl ammonium hydroxide. The catalyst is conventionally added in amounts of 10 to 200 parts per billion (ppb). The preferred polycarbonates for use in the present invention are those catalyzed by a base which is a sodium salt. In general, polycarbonate produced by a sodium hydroxide-catalyzed melt polymerization process contains about 40-70 ppb of base residues derived from the catalyst used. This amounts to 1-1.75×10⁻⁹ equivalents of hydroxide per gram of polycarbonate.

Acidic Quencher

The basic residuals in the compositions of the invention is the result of the reaction of the base-catalyzed reaction product with an acidic quencher which can be any of the various acidic materials known for this purpose. For example, commonly assigned U.S. Pat. No. 5,606,007, which is incorporated herein by reference, discloses the use of both Lewis and Bronsted acidic compounds to quench residual alkalinity. Preferred acidic quenchers are alkyl tosylates, for example n-butyl tosylate, and phosphorus acid, or combinations thereof. (See U.S. Pat. No. 6,136,945. which is incorporated herein by reference).

The amount of acidic quencher is an amount sufficient to substantially neutralize residual basic catalyst, while leaving a small amount of un-neutralized residual base. To produce the residual base levels desirable in the compositions of the invention, amounts of acidic quencher in a 1 to 30-fold molar ratio are desirable. The need for an excess of acidic quencher, even though less than complete neutralization is desired stems from the viscous nature of the polycarbonate product and the very low levels of acid and base involved. These factors mean that even though more than enough acid is added to fully neutralize the base, complete neutralization does not in fact occur. While not intending to be bound by any particular theory, it is believed that pockets of residual base are sufficient to provide the observed increase in solubility, while at the same time not contributing to degradation which is observed in unquenched or insufficiently quenched materials.

As shown in the examples below, amounts of acidic quencher in excess of this amount may lead to deterioration in the fire-retardance in thin materials. In the case where the acidic quencher is butyl tosylate, an appropriate level is in the range of 1 to 10 ppm. In the case where the acidic quencher is phosphorous acid, an appropriate level of quencher is 30-35 ppm.

Flame-Retardant Component

The flame retardant component of the compositions of the invention comprises a potassium perfluoralkane sulfonate and a cyclic siloxane.

The potassium perfluoroalkane sulfate is preferably potassium perfluorobutane sulfonate (Rimar's Salt). The potassium perfluoroalkane sulfonate is suitably present in an amount of from 0.02 to 0.1 phr, based on the total weight of the composition. Higher amounts may lead to undesirable haze formation in the compounded product.

The cyclic siloxane is suitably a compound of the formula: 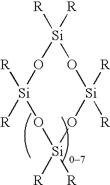
wherein R is independently selected from the group consisting of C₁ to C₃₆ alkyl, fluorinated or perfluorinated C₁ to C₃₆ alkyl, C₁ to C₃₆ alkoxy, C₆ to C₁₄ aryl, aryloxy of 6 to 14 carbon atoms, arylalkoxy of 7 to 36 carbon atoms, and C₁ to C₃₆ alkyl-substituted aryl of 6 to 14 carbon atoms. Specific examples of cyclic siloxanes include, but are not limited to: octaphenylcyclohexamethylcyclotrisiloxane, octamethyldecamethylcyclopentadodecamethylcyclohexasiloxane, trimethyltriphenyl-cyclotrisiloxane, and tetramethyltetraphenylcyclotetrasiloxane.

The cyclic siloxane is suitably present in the composition in an amount from 0.02 to 0.3 phr, based on the total weight of the composition.

As exemplified below in the examples, the polycarbonate, acidic quencher and fire-retardant component work in combination in the compositions of the invention such that the composition achieves a V0 UL flammability rating at a thickness of 2.0 mm or less, for example 1.6 mm or less, and has a haze of no more than 1%. This makes the compositions of the invention suitable for the manufacture of transparent, thin-walled products. Examples of such products includes thin polycarbonate sheets, which may be used for example for computers, business machines and accessories.

The compositions of the invention may include conventional additives which are known in the art for inclusion in polycarbonate compositions. Such additives include but are not limited to stabilizers, mold release agents, light stabilizers, heat stabilizers, pigments and dyes.

The invention will now be further described with reference to the following, non-limiting examples.

### EXAMPLE 1

A polycarbonate resin was melt polymerized in the presence of 80 ppb sodium hydroxide at a reaction temperature of about 290#C. The resulting product had a weight average molecular weight of 29,500 g/mol, as determined by GPC, and contained 2000 ppm of Fries branched impurities (See U.S. Pat. No. 6,184,335). Pellets of the product were extrusion compounded with 0.0925% potassium perfluorobutane sulfonate, 0.08% cyclic octaphenyl siloxane, 0.05% of a heat stabilizer (Irgafos 168), 0.4% PETS mold release, and various levels of butyl tosylate, as an acidic quencher. The compositions were then molded into standard bars at a thickness of 1.6 mm and tested for fire resistance. The results are summarized in Table 1. The 5-Bar Flame Out Times (FOT) were calculated based on 20-Bar Burns.

As shown, the best results were achieved at butyl tosylate addition levels of 1 to 10 ppm. This corresponded to a molar ratio of about 2 to 25, preferably 2.4 to 24. A haze of less than 1% was observed for all formulations.

### EXAMPLE 2

The experiment of Example 1 was repeated, except that phosphorous acid (45 weight % in water) was used as the acidic quencher. The results are summarized in Table 2.

In this case, the best results are achieved with 1 or 2 ppm phosphorous acid, which corresponds to a molar ratio of 1 to 15, which is equivalent to 1 to 30 assuming the phosphorous acid is acting as a monoprotic acid.

### EXAMPLE 3

A polycarbonate resin was melt polymerized in the presence of 105 ppb sodium hydroxide at a reaction temperature of about 290#C. The resulting product had a weight average molecular weight of 27,500 g/mol, as determined by GPC, and contained 1750 ppm of Fries branched impurities. 0.090% potassium perfluorobutane sulfonate, 0.08% cyclic octaphenyl siloxane, 0.05% of a heat stabilizer (Irgafos 168), 0.4% PETS mold release, and 3.5 ppm butyl tosylate were added directly via a losing weight feeder and a side feeder. The pellets were then molded into standard flame bars at a thickness of 1.6 mm and tested. The 5 Bar FOT was 30.6, the Flame Drip was 0/20 and the UL rating was V0. In this example, the mole ratio is 2.6. Excellent flame retardance characteristics were observed, even at the lower level of flame retardant.

### EXAMPLE 4

Polycarbonate, made as per Example 3 above, was formulated with a lower loading at 0.05% of potassium perfluorobutane sulfonate. All the other additive loadings were maintained as in Example 3. Pelletization, followed by molding of flame bars at 3.2 mm resulted in robust V0 with a 5 Bar FOT of 24.2 sec. Transparency was good with haze <1%.

### EXAMPLE 5

Polycarbonate, made as per Example 3 above, was formulated with a higher loading at 0.1% of potassium perfluorobutane sulfonate. The other three additive loadings, namely cyclic Siloxane, heat stabilizer and mold release, were maintained as in Example 3, but the butyl tosylate loading was 4 ppm. Pelletization, followed by molding of flame bars at 1.6 mm resulted in robust V0 with a 5 Bar FOT of 27 sec. Even though the loading of potassium perfluorobutane sulfonate was higher (0.1%) the transparency was still good with haze <1%.

1. A polycarbonate composition comprising:
(a) polycarbonate produced in a base-catalyzed melt polymerization reaction to which an acidic quencher has been added in a 1 to 30-fold molar ratio with respect to the amount of initial basic catalyst; and
(b) a flame-retardant component comprising a potassium perfluoralkane sulfonate and a cyclic siloxane, wherein components (a) and (b) work in combination such that the composition achieves a V0 UL flammability rating at a thickness of 2 mm and has a haze of no more than 1%.

2. The composition of claim 1, wherein the base catalyst employed in the base-catalyzed melt polymerization reaction is a sodium salt.

3. The composition of claim 2, wherein components (a) and (b) work in combination such that the composition achieves a V0 UL flammability rating at a thickness of 1.6 mm.

4. The composition of claim 3, wherein the cyclic siloxane has the 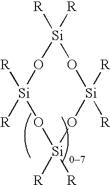
wherein R is independently selected from the group consisting of C₁ to C₃₆ alkyl, fluorinated or perfluorinated C₁ to C₃₆ alkyl, C₁ to C₃₆ alkoxy, C₆ to C₁₄ aryl, aryloxy of 6 to 14 carbon atoms, arylalkoxy of 7 to 36 carbon atoms, and C₁ to C₃₆ alkyl-substituted aryl of 6 to 14 carbon atoms.

5. The composition of claim 4, wherein the potassium perfluoroalkane sulfonate is potassium perfluorobutane sulfonate.

6. The composition according to claim 5, wherein the acidic quencher is butyl tosylate at a level of 1 to 10 ppm.

7. The composition according to claim 5, wherein the acidic quencher is phosphorous acid at a molar ratio of 1 to 15 with respect to the initial base catalyst.

8. The composition according to claim 4, wherein the acidic quencher is butyl tosylate at a level of 1 to 10 ppm.

9. The composition according to claim 4, wherein the acidic quencher is phosphorous acid at a molar ratio of 1 to 15 with respect to the initial base catalyst.

10. The composition of claim 2, wherein the cyclic siloxane has the 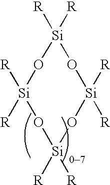
wherein R is independently selected from the group consisting of C₁ to C₃₆ alkyl, fluorinated or perfluorinated C₁ to C₃₆ alkyl, C₁ to C₃₆ alkoxy, C₆ to C₁₄ aryl, aryloxy of 6 to 14 carbons atoms, arylalkoxy of 7 to 36 carbon atoms, and C₁ to C₃₆ alkyl-substituted aryl of 6 to 14 carbon atoms.

11. The composition of claim 10, wherein the potassium perfluoroalkane sulfonate is potassium perfluorobutane sulfonate.

12. The composition according to claim 11, wherein the acidic quencher is butyl tosylate at a level of 1 to 10 ppm.

13. The composition according to claim 11, wherein the acidic quencher is phosphorous acid at a molar ratio of 1 to 15 with respect to the initial base catalyst.

14. The composition according to claim 10, wherein the acidic quencher is butyl tosylate at a level of 1 to 10 ppm.

15. The composition according to claim 10, wherein the acidic quencher is phosphorous acid at a molar ratio of 1 to 15 with respect to the initial base catalyst.

16. The composition of claim 2, wherein the base catalyst employed in the base-catalyzed melt polymerization reaction is sodium hydroxide.

17. The composition of claim 16, wherein components (a) and (b) work in combination such that the composition achieves a V0 UL flammability rating at a thickness of 1.6 mm.

18. The composition of claim 17, wherein the cyclic siloxane has the 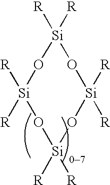
wherein R is independently selected from the group consisting of C₁ to C₃₆ alkyl, fluorinated or perfluorinated C₁ to C₃₋₆ alkyl, C₁ to C₃₆ alkoxy, C₆ to C₁₄ aryl, aryloxy of 6 to 14 carbon atoms, arylalkoxy of 7 to 36 carbon atoms, and C₁ to C₃₆ alkyl-substituted aryl of 6 to 14 carbon atoms.

19. The composition of claim 18, wherein the potassium perfluoroalkane sulfonate is potassium perfluorobutane sulfonate.

20. The composition according to claim 19, wherein the acidic quencher is butyl tosylate at a level of 1 to 10 ppm.

21. The composition according to claim 19, wherein the acidic quencher is phosphorous acid at a molar ratio of 1 to 15 with respect to the initial base catalyst.

22. The composition according to claim 18, wherein the acidic quencher is butyl tosylate at a level of 1 to 10 ppm.

23. The composition according to claim 18, wherein the acidic quencher is phosphorous acid at a molar ratio of 1 to 15 with respect to the initial base catalyst.
